(19) United States
(12) Patent Application Publication
(10) Pub. No.: US 2021/0243934 A1
(43) Pub. Date: Aug. 12, 2021

(54) AGRICULTURAL DEVICE

(71) Applicant: Lemken Gmbh & Co KG, Alpen (DE)

(72) Inventors: Georg Paulessen, Willich (DE); Florian Koch, Wesel (DE); Michael Janssen, Kevelaer (DE); Johannes Nepicks, Alpen (DE)

(21) Appl. No.: 16/972,570

(22) PCT Filed: Jun. 5, 2019
(86) PCT No.: PCT/DE2019/100498

§ 371 Date: Dec. 4, 2020

(30) Foreign Application Priority Data
Jun. 5, 2018 (DE) 10 2018 208 852.7
Jun. 6, 2018 (DE) 10 2018 208 964.7

(51) Int. Cl. A01B 63/22; A01B 63/00

(52) U.S. Cl. CPC A01B 63/22; A01B 63/002

(57) ABSTRACT

In order to ensure a smooth running with a cost-efficient embodiment of its structural design, an agricultural device (1) has a frame (10) comprising a middle section (10a) and can be connected to a hauler by means of a mounting region (19) of the frame (10). The agricultural device further comprises a first support wheel (20), which is supported relative to the frame (10) by means of a first support mechanism, and a second support wheel (30), which is supported relative to the frame (10) by means of a second support mechanism. The agricultural device is characterized in that the first support and second support mechanism are coupled to one another and are in contact with an energy storage, so that the first support wheel (20) and the second support wheel (30) can be positioned relative to the frame (10) under force control so as to be aligned.

The invention relates to an agricultural device, which is connected to a hauler or the like and which can be pulled for working the soil.

Pulled agricultural devices are usually connected via a centrally arranged mounting region to a hauler, so that the latter can move the device by pulling it during the transport or when working the soil. When working the soil, the mounting region thereby forms the front point of a so-called triangle of support, which is formed between the mounting region and rollers of the device.

However, as the operating width increases, thus as the dimension of the device increases transversely to the direction of movement while the length remains the same or essentially the same, the triangle of support becomes increasingly blunter. As a result, an increasing portion of the operating tools provided at the agricultural device is located outside of the triangle of support spanned between the mounting region and the rollers of the device, so that the agricultural device tends to wobble and overturn.

To counteract this situation, leading support wheels are provided at an agricultural device of this type. It is technically challenging, however, to integrate these support wheels into the overall system.

As the effectively simplest solution, the leading support wheels can be adjusted mechanically or hydraulically, and remain in a state, which is fixed relative to the frame of the agricultural device, when working the soil. However, this leads to the agricultural device being guided by the support wheels, the mounting region at the hauler, and the trailing roller. In other words, the system is mechanically overconstrained and the actual ratio of bearing contact area to total area of the components varies as a function of the setting of the device and of the topography of the soil. If the agricultural device is pulled across an uneven terrain, this thus leads to highly fluctuating ratios of bearing contact area to total area of the respective components, so that all of the components of the device, which optionally bear the weights, have to each be designed for an extreme load situation. This leads to a relatively high structural effort and thus to corresponding costs. In addition, the weight of the agricultural device increases.

In the case of an agricultural device, it is further known to use rigid support wheels and a drawbar, which is vertically freely movable and by means of which only tractive forces would need to be transferred. The system is thus not mechanically overconstrained. However, it has turned out to be a disadvantage that no bearing load can be transferred to the hauler.

Systems, which can be actively controlled in general, are known as further alternatives. Actively controlled systems, however, are relatively complex and thus cost-intensive. In addition, an additional energy source has to be provided, which has to be kept, for example, at the hauler, and which has to be connected to the agricultural device.

It is a goal of the invention to provide an agricultural device comprising support wheels, in order to ensure a smooth running of the agricultural device, wherein the structural design is to provide for a cost-efficient embodiment.

The subject matter of claim 1 provides a corresponding agricultural device. Further preferred embodiments are listed in the dependent claims.

The agricultural device comprises a frame comprising a middle section, wherein the agricultural device can be connected to a hauler by means of a mounting region of the frame. A first support wheel, which is supported relative to the frame by means of a first support mechanism, and a second support wheel, which is supported relative to the frame by means of a second support mechanism, are further provided.

The first support mechanism and the second support mechanism are thereby coupled to one another and are in contact with an energy storage, so that the first support wheel and the second support wheel can be positioned relative to the frame under force control so as to be aligned.

A ratio of bearing contact area to total area is assigned to the support wheels of the agricultural device according to the invention, in the case of which the stabilization of the agricultural device is ensured. Due to the fact that the support wheels are coupled to one another, they always have the same height ratio to the frame. The remaining weight is taken over by the hauler/towing vehicle and the trailing rollers. When working the soil, a triangle of support is formed between the mounting region and the trailing rollers, wherein the trailing rollers are in particular supported in a pendulum fashion.

The support wheels are coupled in such a way that they move parallel to one another. Due to the coupling, a biasing pressure is thereby defined via an energy storage, so that the support wheels can be positioned relative to the frame under force control so as to be aligned. The agricultural device according to the invention is thus constructively embodied in such a way that a comparatively cost-efficient solution can be provided.

The agricultural device can have a chassis, by means of which the agricultural device is supported when being transported on the road. As an alternative to a chassis, the agricultural device can also be coupled to the hauler by means of a three-point linkage, so that the agricultural device is raised when being transported on the road.

In one embodiment, it is provided that the first support mechanism has a first cylinder, and the second support mechanism has a second cylinder, wherein the first and second cylinder are coupled to one another by means of a hydraulic system. This provides for a precise guidance of the support wheels.

It is preferred that the hydraulic system comprises a first hydraulic line and a second hydraulic line. A precise guidance of the support wheels is thus possible.

It is further preferred that the hydraulic system comprises a hydraulic accumulator as energy storage, which is formed as bladder accumulator, in particular nitrogen accumulator, wherein the hydraulic accumulator is fluidically connected to the first or second hydraulic line. The force, with which the support wheels push jointly, is thus defined by the biasing pressure in the bladder accumulator.

According to a further alternative, it is provided that the first hydraulic line is connected to the side of the first cylinder acting in the direction of the first support wheel, and to the side of the second cylinder acting away from the second support wheel, and that the second hydraulic line is connected to the side of the first cylinder acing away from the first support wheel, and to the side of the second cylinder acting in the direction of the second support wheel. A master-slave combination is provided in this way, by means of which it is ensured that the support wheels are always moved in parallel.

It is preferred that the hydraulic system comprises a coupling hydraulic line, in order to couple the first and second cylinder, wherein a spring, in particular a compression spring, is provided as energy storage, which exerts a compressive force on a piston of the first and/or second cylinder. A compact and reliable assembly is thus provided.

In the alternative or in addition, it is possible that the first and second support mechanism are coupled by means of a coupling rod, wherein a spring, in particular compression spring, is provided as energy storage, in order to support the coupling rod with respect to the frame. This embodiment has turned out to be extremely robust for the use in agriculture.

The frame can comprise a first frame wing and a second frame wing, which extend from the middle section in opposite directions, wherein the first support wheel is arranged in an end region of the first frame wing, and the second support wheel is arranged in an end region of the second frame wing.

One or several working implements/working tools, for example one or several disk harrows, can in each case be attached to the first frame wing and to the second frame wing.

It is preferred that the first frame wing is in contact with the middle section by means of a first adjusting means, and that the second frame wing is in contact with the middle section by means of a second adjusting means, so that the first frame wing and the second frame wing can be pivoted relative to the middle section. The agricultural device can thus be arranged in a compact manner and can be transported accordingly while being transported on the road.

It is preferred that the first support wheel is attached to a hinge element, which is connected to the frame by means of a hinge, and that the second support wheel is attached to a hinge element, which is connected to the frame by means of a hinge. A robust embodiment of the agricultural device is thus ensured.

The first support wheel and the second support wheel are preferably identically spaced apart from the middle section of the frame, in order to ensure a homogenous support on both sides.

It is further provided according to an embodiment that the frame is formed in several parts, wherein a rear region in the driving direction comprises the chassis, and a front region in the driving direction comprises the support wheels, wherein the front region and the rear region can be moved relative to one another. The agricultural device can thus be modified between a setup, which is suitable for being transported on the road, and a configuration, which is preferred for work. In the latter case, the trailing roller(s) can take over a support of the agricultural device with respect to the soil.

It is preferred that the first support wheel and the second support wheel are arranged in front of the chassis in the driving direction, so that the support wheels represent so-called leading support wheels.

The first support wheel and the second support wheel can in each case have a smaller diameter than wheels of the chassis. The support wheels are thus designed for the comparatively slow use, in particular when working the soil by means of the agricultural device.

The first support wheel and the second support wheel can additionally be height-adjustable, in order to be able to preset the support wheels.

It is provided in a further alternative that the weight of the frame is essentially absorbed by a trailing roller and, when the agricultural device is mounted to a hauler, by a hauler, which is connected to the mounting region. A smaller ratio of bearing contact area to total area is thus absorbed by the support wheels, in order to prevent an overturning of the agricultural device.

It is provided in a further embodiment that the agricultural device has one or several further support wheels, which are provided in addition to the first and second support wheel. The or the further support wheels are preferably provided in connection with the first and second support wheel. The range of applications of the agricultural device can be expanded even further in this way.

In addition to the agricultural device itself, the invention also relates to the use of the agricultural device according to one of the preceding aspects for working the soil.

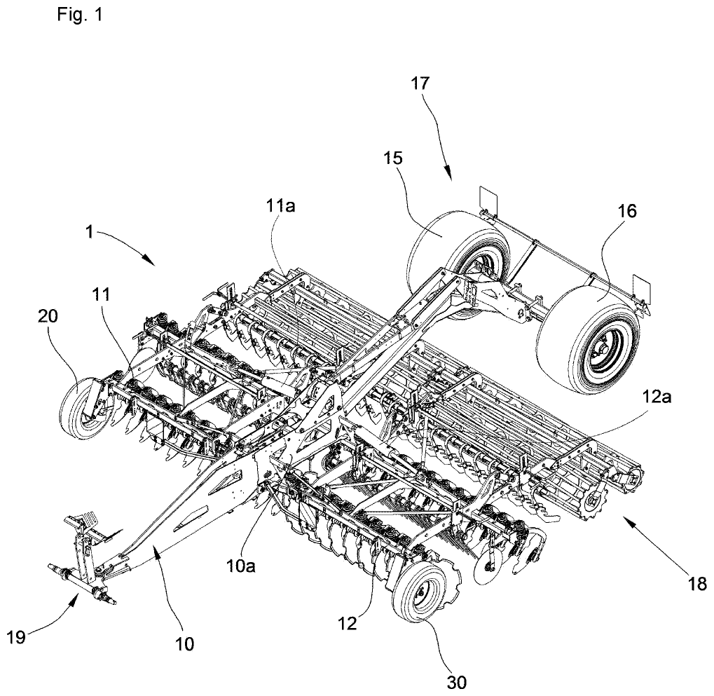

FIG. 1 is a perspective illustration of a first embodiment of the agricultural device according to the invention

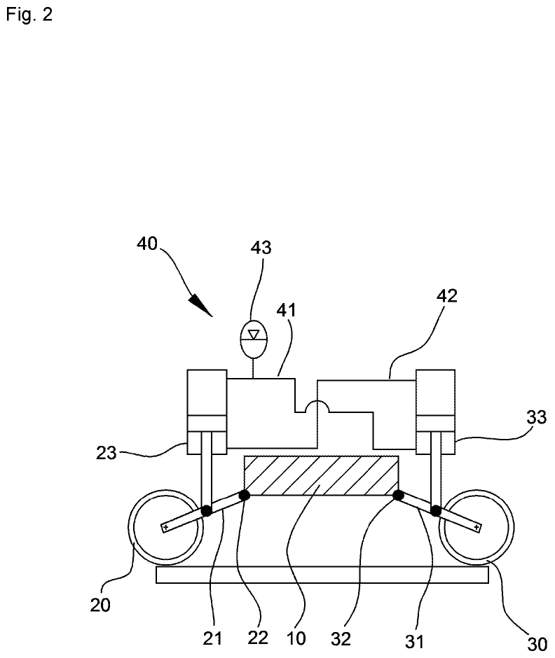

FIG. 2 shows a schematic illustration of the agricultural device according to the first embodiment

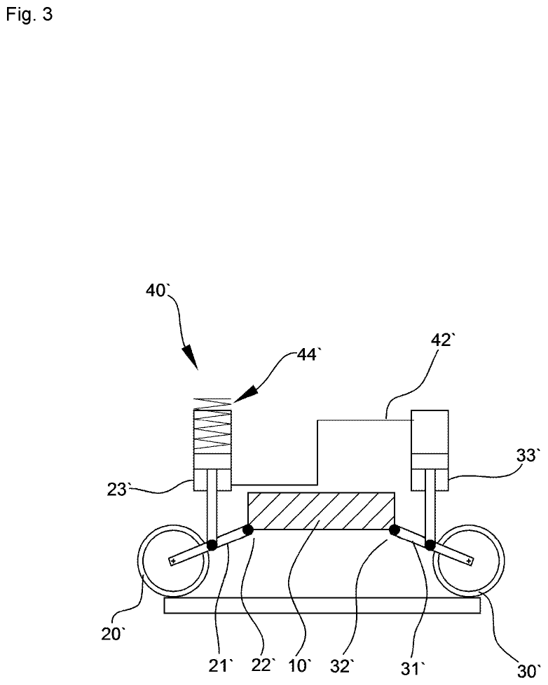

FIG. 3 shows a schematic illustration of the agricultural device according to a second embodiment

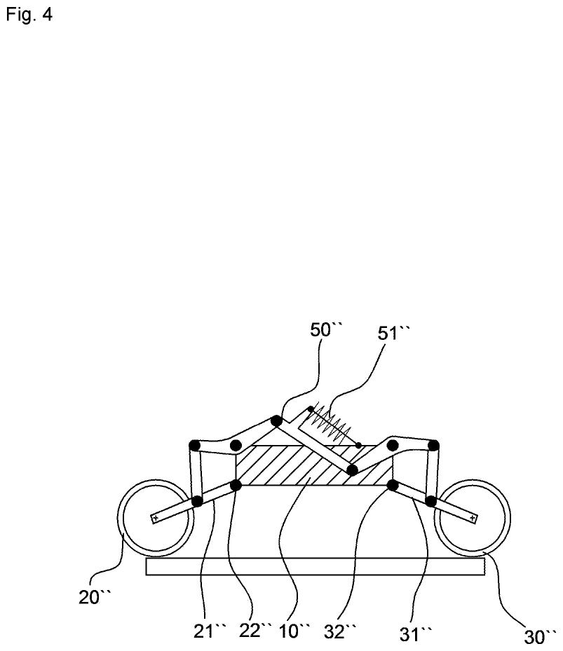

FIG. 4 shows a schematic illustration of the agricultural device according to a third embodiment

Preferred embodiments of the invention are described on the basis of the figures, in order to describe the invention on the basis of concrete examples. Even though the embodiments are not restrictive, but purely exemplary, features of the embodiments can also be used individually to specify the invention. Modifications of features of the embodiment can be combined with alternatives of other features of the embodiment, in order to form further embodiments of the invention.

FIG. 1 shows a first embodiment of an agricultural device 1 according to the invention. The agricultural device 1 comprises a frame 10, which has a middle section 10a, which extends centrally. The frame 10 comprises a mounting region 19, which forms a front section of the agricultural device 1 in the driving direction, and which can be connected to a hauler, in particular a tractor. A chassis 17, which comprises two wheels 15, 16, is provided on the opposite side of the mounting region 19. If the agricultural device 1 is pulled, for example, over a road, the agricultural device 1 is primarily supported via the wheels 15, 16 as well as via the mounting region 19.

Frame wings 11, 12, which each accommodate working implements, extend on both sides, starting at the middle section 10a of the frame 10. In the driving direction between the frame wings 11, 12 and the wheels 15, 16, trailing rollers 18 are provided, which take over a support of the agricultural device 1 when working the soil. In the exemplary embodiment, the trailing rollers 18 are supported in a pendulum fashion.

When working the soil, a triangle of support is formed between the mounting region 19 and the trailing rollers 18. The tips of the triangle of support in the region of the rollers 18 is thereby located between an outermost section of the trailing rollers 18 and an extension of the middle section 10a of the frame 10.

The first frame wing 11 is in contact with the middle section 10a of the frame 10 by means of a first adjusting means 11a, which is formed as hydraulic cylinder in the present case. The second frame wing 12 is therefore in contact with the middle section 10a of the frame 10 by means of a second adjusting means 12a, which is likewise formed as hydraulic cylinder in the exemplary embodiment. The frame wings 11, 12 can each be pivoted relative to the middle section 10a of the frame 10 by means of the adjusting means 11a, 12a.

A first support wheel 20 is provided at an end of the first frame wing 11, which points away from the middle section 10a of the frame 10, and a second support wheel 30 is provided at an end of the second frame wing 12, which points away from the middle section 10a of the frame 10.

In the present exemplary embodiment, the support wheels 20, 30 are so-called leading support wheels, because the engagement region of the working tools, which are mounted to the frame wing, and the engagement region of the trailing rollers 18 are located downstream in the driving direction.

The coupling of the first support wheel 20 and of the second support wheel 30 can be described concretely on the basis of FIG. 2. The first support wheel 20 is in particular in contact with the frame 10 by means of a hinge element 21, and can be pivoted around a hinge 22 relative to the frame by means of the hinge element 21. The second support wheel 30 is mounted to a hinge element 31, wherein the hinge element 31 is connected to the frame 10 by means of a hinge 32. The second support wheel 30 can thus be pivoted relative to the frame 10.

A first cylinder 23, which accommodates a piston, is provided in the region of the first support wheel 20. The piston of the first cylinder 23 is in contact with the hinge element 21 and supports the latter relative to the frame 10.

A second cylinder 33, which accommodates a piston element, is provided in the region of the second support wheel 30. The piston element of the second cylinder 33 supports the hinge element 31 relative to the frame 10.

The cylinders 23, 33 are coupled to one another in a master-slave combination. The upper cylinder chamber of the first cylinder 23 is in particular in contact with a lower cylinder chamber of the second cylinder 33 by means of a hydraulic line 41 of a hydraulic system 40. The lower cylinder chamber of the first cylinder 23 is in contact with the upper cylinder chamber of the second cylinder 33 by means of a second hydraulic line 42 of the hydraulic system 40.

In the present exemplary embodiment, a hydraulic accumulator (energy storage), which is formed as so-called bladder accumulator in the present case, is connected to the first hydraulic line 41. A defined biasing pressure, which is defined by a nitrogen accumulator, is thus provided in the hydraulic accumulator 43. The force, with which the support wheels 20, 30 are pushed jointly, is defined by the biasing pressure in the nitrogen bladder of the hydraulic accumulator.

A second embodiment is explained on the basis of FIG. 3. Similar elements as in the first embodiment are identified with corresponding reference numerals. In addition to the following explanations, reference is also made to the preceding description of the first embodiment. This relates in particular to the structural setup of the agricultural device according to FIG. 1, which can be realized similarly in the embodiment according to FIG. 3.

The second embodiment relates to an agricultural device comprising a frame 10′, wherein the agricultural device has a first support wheel 20′ and a second support wheel 30′. The first support wheel 20′ is in contact with the frame 10′ by means of a hinge element 21′, and can be pivoted around a hinge 22′ relative to the frame by means of the hinge element 21′. The second support wheel 30′ is mounted to a hinge element 31′. The hinge element 31′ is connected to the frame 10′ by means of a hinge 32′, so that the second support wheel 30′ can be pivoted relative to the frame 10′.

The agricultural device of the second embodiment comprises a first cylinder 23′, which is supported on the hinge element 21′ of the first support wheel 20′. A second cylinder 33′ is further provided, which is supported on the hinge element 31′ of the second support wheel 30′. The lower chamber of the first cylinder 23′ is in fluidic contact with an upper chamber of the second cylinder 33′ by means of a coupling hydraulic line 42′ of a hydraulic system (40′). The cylinders 23′ and 33′ are thus coupled to one another. A spring 44′, which serves as energy storage and which biases the piston of the first cylinder 23′, is provided at the first cylinder 23′. The spring 44′ thus serves as energy storage, so that the first support wheel 20′ and the second support wheel 30′ can be positioned relative to the frame 10′ under force control so as to be aligned.

FIG. 4 shows a third embodiment of the invention. Similarly to the components as in the first embodiment, corresponding reference numerals are in fact identified. In addition to the following explanation of the third embodiment, reference is made to the explanations relating to the first embodiment. This applies in particular for the detailed description relating to FIG. 1 of the first embodiment

The third embodiment relates to an agricultural device comprising a frame 10″, wherein the agricultural device has a first support wheel 20″ and a second support wheel 30″. The first support wheel 20″ is in contact with the frame 10″ by means of a hinge element 21″, and can be pivoted around a hinge 22″ relative to the frame by means of the hinge element 21″. The second support wheel 30″ is mounted to a hinge element 31″. The hinge element 31″ is connected to the frame 10″ by means of a hinge 32″, so that the second support wheel 30″ can be pivoted relative to the frame 10″.

The second embodiment differs from the first embodiment in that instead of hydraulic cylinders, a mechanical coupling is provided between the first support wheel 20″ and the second support wheel 30″. The agricultural device according to the third embodiment, in particular comprises a coupling rod 50″, which is in each case in contact with the hinge elements 21″ and 31″ by means of a toggle lever mechanism, wherein the coupling rod 50″ is supported with respect to the frame 10″ by means of a compression spring 51″. The compression spring 51″ thereby serves as energy storage, so that the first support wheel 20″ and the second support wheel 30″ can be positioned relative to the frame 10″ under force control so as to be aligned.

It can be seen that the agricultural device according to the embodiments can be expanded by additional working tools.

Even though the embodiments were described on the basis of an agricultural device, which is equipped with working tools for working the soil, it can be seen that the agricultural device according to further embodiments can also be formed for a different use, for example as tedder or the like.

1. An agricultural device (1), which has a frame (10) comprising a middle section (10a) and which can be connected to a hauler by means of a mounting region (19) of the frame (10), further comprising:
a first support wheel (20), which is supported relative to the frame (10) by means of a first support mechanism,
a second support wheel (30), which is supported relative to the frame (10) by means of a second support mechanism,
characterized in
that the first and second support mechanism are coupled to one another and are in contact with an energy storage (43, 44′, 51″), so that the first support wheel (20) and the second support wheel (30) can be positioned relative to the frame (10) under force control so as to be aligned.

2. The agricultural device (1) according to claim 1,
characterized in
that the first support mechanism has a first cylinder (23), and the second support mechanism has a second cylinder (33), wherein the first and second cylinder are coupled to one another by means of a hydraulic system (40, 40′).

3. The agricultural device (1) according to claim 2,
characterized in
that the hydraulic system (40) has a first hydraulic line (41) and a second hydraulic line (42), and the hydraulic system (40) comprises a hydraulic accumulator (43) as energy storage, which is formed as bladder accumulator, wherein the hydraulic accumulator (43) is fluidically connected to the first or second hydraulic line.

4. The agricultural device (1) according to claim 3,
characterized in
that the first hydraulic line (41) is connected to the side of the first cylinder (23) acting in the direction of the first support wheel (20), and to the side of the second cylinder (33) acting away from the second support wheel (30), and that the second hydraulic line (42) is connected to the side of the first cylinder (23) acing away from the first support wheel (20), and to the side of the second cylinder (33) acting in the direction of the second support wheel (30).

5. The agricultural device (1) according to claim 2,
characterized in
that the hydraulic system (40′) comprises a coupling hydraulic line (42′), in order to couple the first and second cylinder, wherein a spring, in particular a compression spring, is provided as energy storage, which exerts a compressive force on a piston of the first and/or second cylinder (23′, 33′).

6. An agricultural device (1) according to claim 1,
characterized in
that the first and second support mechanism are coupled by means of a coupling rod (50″), wherein a spring (51″), in particular compression spring, is provided as energy storage, in order to support the coupling rod (50″) with respect to the frame (10).

7. The agricultural device (1) according to claim 1,
characterized in
that the frame (10) comprises a first frame wing (11) and a second frame wing (12), which extend from the middle section (10a) in opposite directions, wherein the first support wheel (20) is arranged in an end region of the first frame wing (11), and the second support wheel (30) is arranged in an end region of the second frame wing (12).

8. The agricultural device (1) according to claim 7, characterized in that one or several working implements, for example one or several disk harrows, are in each case attached to the first frame wing (11) and to the second frame wing (12).

9. The agricultural device (1) according to claim 7,
characterized in
that the first frame wing (11) is in contact with the middle section (10a) by means of a first adjusting means (11a), and that the second frame wing (12) is in contact with the middle section (10a) by means of a second adjusting means (12a), so that the first frame wing (11) and the second frame wing (12) can be pivoted relative to the middle section (10a).

10. The agricultural device (1) according to claim 1, that the first support wheel (20) is attached to a hinge element (21), which is connected to the frame by means of a hinge (22), and that the second support wheel (30) is attached to a hinge element (31), which is connected to the frame by means of a hinge (32).

11. The agricultural device (1) according to claim 1, that the first support wheel (20) and the second support wheel (30) are identically spaced apart from the middle section (10a).

12. The agricultural device (1) according to claim 1,
characterized in
that the frame (10) is formed in several parts, wherein a rear region in the driving direction comprises the chassis (17), and a front region in the driving direction comprises the support wheels (20; 30), wherein the front region and the rear region can be moved relative to one another.

13. The agricultural device according to claim 1, characterized in
that the first support wheel (20) and the second support wheel (30) are arranged in front of the chassis (17) in the driving direction, and/or
the first support wheel (20) and the second support wheel (30) in each case have a smaller diameter than wheels (15, 16) of the chassis (17), and/or
the first support wheel (20) and the second support wheel (30) are additionally height-adjustable.

14. The agricultural device according to claim 1, characterized in
that the weight of the frame (10) is essentially absorbed by a trailing roller (18) when working the soil and, when the agricultural device is mounted to a hauler, by a hauler, which is connected to the mounting region (19).

15. The agricultural device according to claim 1, characterized in
that the agricultural device has a further support wheel or several further support wheels.
